(19) United States
(12) Patent Application Publication
(10) Pub. No.: US 2010/0307426 A1
(43) Pub. Date: Dec. 9, 2010

(54) RE-ORIENTABLE PET BRUSH

(75) Inventor: Patrick M. Bertsch, Thornton, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Doskocil Manufacturing Company, Inc., Arlington, TX (US)

(21) Appl. No.: 12/477,718

(22) Filed: Jun. 3, 2009

(51) Int. Cl. A01K 13/00

(52) U.S. Cl. 119/601; 119/633; 119/627

(57) ABSTRACT

A pet brush with a re-orientable pet brush head. The pet brush may include a mechanism controlling the brush head to brush handle orientation through a shaped connector and complementary shaped hole or receiver. The pet brush may also include a mechanism controlling the brush head to brush handle orientation through prongs and prong receptors on the brush head and brush handle.

### FIELD OF INVENTION

The present invention generally relates to pet brushes, and more specifically to the pet brushes with re-orientable brush heads.

### BACKGROUND

Often, an owner of a furry pet may have his or her pet groomed with a brush to remove excess pet hair and foreign matter. Such brushes may be multi-directional or uni-directional. Multi-directional brushes have brushes with bristles that provide the same result regardless of the orientation of the brush bristles in relation to the direction of the brush stroke. In contrast, uni-directional brushes are brushes with typically better grooming results because the brush bristles counterpose the direction of the brush stroke. Because of these counterposing bristles, uni-directional brushes operate best when brushing along one axis, which is defined by the fixed position of the brush head with respect to the brush handle.

Uni-directional brushes are often used by many owners of furry pets because of one or more of the benefits described above. However, many pets have fur which groomers must comb or brush in different directions, like head to foot as well as head to tail. In order to perform these various directions of combing or brushing with a uni-directional brush, a pet groomer must either move the pet or move around the pet which, among other things, can be time consuming and lead to inefficiencies. Accordingly, there is a need in the art for improving pet brushes to reduce movement by a groomer or a pet during grooming, including instances where grooming involves a uni-directional brush.

### SUMMARY

One embodiment of the present invention takes the form of a pet brush that controls orientation through the use of a shaped connector and a shaped receiver located on the brush head and brush handle respectively. The pet brush has a mechanism which releasably couples the pet brush head to the pet brush handle. As part of this mechanism, there is a shaped connector on the brush head and a complementary shaped socket, receiver or hole on the brush handle. When the brush head connector is inserted into the brush handle socket, the shapes of the connector and socket controls the orientation of the brush head to the brush handle. In this example, a square shape is used to control the orientation in 90 degree increments. Other shapes may be used to achieve different orientations of the brush head to the brush handle.

Another embodiment takes the form of a pet brush that controls orientation of the pet brush head to the pet brush handle through prongs and prong receptacles located on the brush head and brush handle respectively. The pet brush has a mechanism which releasably couples the pet brush head to the pet brush handle. As part of this mechanism, there are prongs located in a shaped pattern on the brush head and a prongs receptors located in a shaped pattern on the brush handle. When the brush head is connect to the brush handle the prongs on the brushed head set into the prong receptacles on the brush handle to control the brush head to brush handle orientation. In this example, a square pattern is used to control the orientation in 90 degree increments. Other patterns may be used to achieve different orientations of the brush head to the brush handle.

These and other advantages and features of the present invention will become apparent to those of ordinary skill in the art upon reading the disclosure in its entirety.

### BRIEF DESCRIPTION OF THE DRAWINGS

FIG. 1 is a isometric view of an embodiment of a pet brush.

FIG. 2 is an exploded view of the embodiment shown in FIG. 1.

FIG. 3 is a sectional view of the brush handle of FIG. 1 showing an internal skeleton and an over-molded body of the brush handle taken along line 6-6 of FIG. 1.

FIG. 4 is a sectional view of the mechanism of FIG. 1 showing an engaged sliding lock which orients the brush head and handle taken along line 3-3 of FIG. 1.

FIG. 5 is sectional view FIG. 4 showing the sliding lock as it is disengaged.

FIG. 6 is a view of the embodiment of FIG. 1 depicting a bottom face of the brush handle and a top face of the brush head.

FIG. 7 is a lateral cross-sectional view of the embodiment of FIG. 1 showing an uncoupled brush head and brush handle taken along line 6-6 of FIG. 1.

FIG. 8 is lateral cross-sectional view FIG. 7 showing a coupled brush head and brush handle taken along line 6-6 of FIG. 1.

### DETAILED DESCRIPTION

Generally, one embodiment takes the form of a brush having a brush head and a brush handle coupled together using a quick-release mechanism. As described further below, the brush head can be reoriented with respect to the brush handle and reattached in its new orientation by means of the quick-release mechanism. This change in orientation of the brush head with respect to the brush handle permits the brush head, and thus optionally the direction of use of the brush, to be adjusted for various grooming tasks.

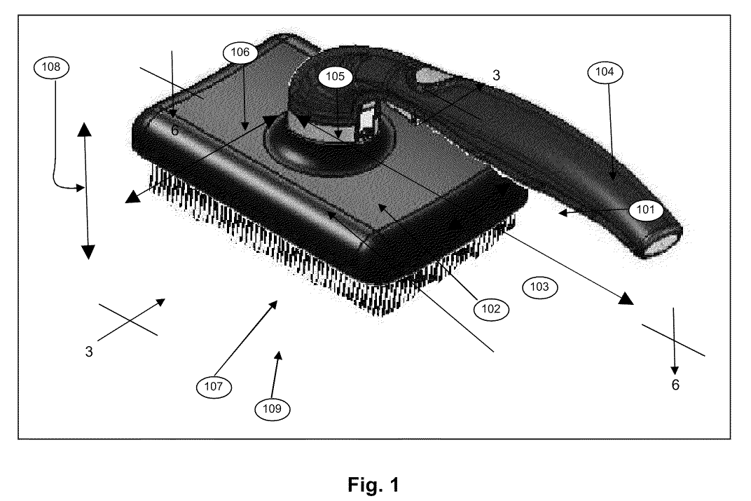

An embodiment of the brush is shown in FIG. 1. The brush includes a brush head 102 and brush handle 101 which are coupled by a mechanism 103 which orients the brush head to the brush handle. Although the embodiment locates the mechanism 103 on the brush handle 101, it may be appreciated that the mechanism can be located on the brush head 102 instead of the brush handle. Furthermore, this embodiment has the brush head 102 attaching to the brush handle 101 at the end of the brush handle. However, it should be appreciated that the brush head 102 may attach to any portion of the brush handle 101.

FIG. 1 shows an embodiment of the brush handle 101 that is a length 105 of 7.5 inches and a diameter 104 of a region where a user may grasp or hold the pet brush during use. The handle length is not limited to 7.5 inches and can range from 6.5 inches to 8.5 inches in other embodiments. However, it may be appreciated that the length of the handle can be larger or shorter than this range.

FIG. 1 shows an embodiment of the brush head 102 holding uni-directional brush bristles 109. The brush head 102 is a length 107 of 3.96 inches, a width 106 of 2.1 inches, and a total height 108 of 1.66 inches including the brush bristles. The brush head 102 is typically made of a molded plastic but may be formed from any material which can be securely held by the mechanism 103 and the brush handle 101. The brush bristles 109 are typically made of metal but may be made from other material including made plastic and other synthetic or natural fibers. Although this embodiment uses a uni-directional brush, it may be appreciated the brush head may be made of combs or other multi-directional brushes and that the combs, and uni-directional and multi-directional brushes can be of varying heights and dimensions adequate for grooming of animal hair or fur.

The mechanism 103 of FIG. 1 is typically made of plastic or metal which securely couples the brush head 102 to the brush handle 101.

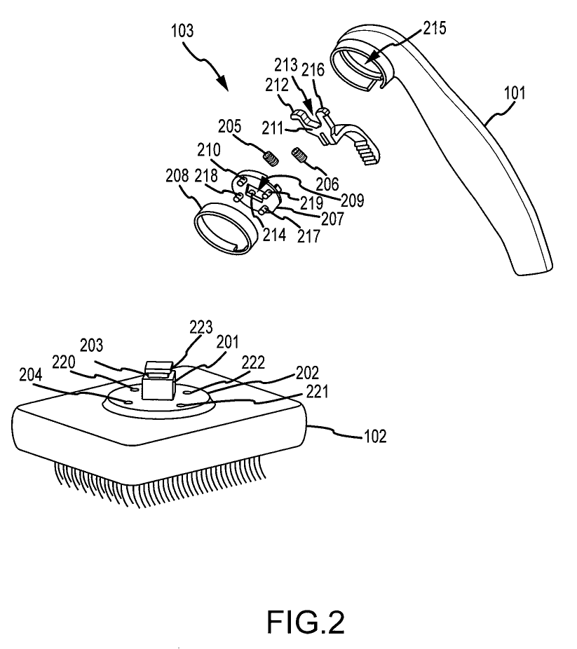

FIG. 2 is an exploded view of the embodiment including the brush handle 101 and brush head 102. The view depicts one embodiment of the associated components of the coupling and orientation mechanism 103 from FIG. 1 including a sliding lock 211, two springs 205 and 206, a cover plate 207 and an end cap 208. In this embodiment, an assembled mechanism has the back face of the cover plate 207 abutting the front face of the sliding lock 211. A first spring 205 is located on the left side of the sliding lock and sits between an arm 212 on the sliding lock 211 and a left-side spring-base arm 214 on the back of the cover plate 207. A second spring 206 is similarly located between an arm 216 on the right side of the sliding lock and spring-base arm (not shown) on the right side of the cover plate. The operation of these springs and the sliding lock and cover plate is described further below. The end cap 208 secures the cover plate 207, the springs 205 and 206, and the sliding lock 211 to the brush handle 101 in a receptacle 215 situated on the end of the brush handle. In this embodiment, none of the components of the orientation mechanism, including the end cap 208, cover plate 207, springs 205 and 206, and sliding lock 211, turn or rotate on the brush handle to perform the reorientation of the brush head to the brush handle. However, it should be appreciated that, in certain embodiments, the mechanism itself may turn or rotate. As one example, a ratchet-like mechanism that rotates but can be locked into secure position may be employed.

FIG. 2 also depicts the brush head 102 that couples with the mechanism 103, including a brush head connector 201 and a brush connector base 202. The brush head connector 201 is held at the end 223 by the mechanism 103 in the brush handle 101 to secure the brush head to the brush handle. The brush head connector end 223 is inserted into the mechanism 103 through a hole 209 in the cover plate 207. After passing through the cover plate hole 209, the brush head connector end 223 enters a gap 213 between the sliding-lock arms 212 and 216. After the brush head connector end 223 passes between the sliding-lock arms 212 and 216, the sliding lock 211 rests in a notch 203 in the brush head connector. The sliding lock is biased into the notch 203 by springs 205 and 206. This bias of the sliding lock into the notch secures the brush head 102 to the brush handle 101 and prevents removal of the brush head from the brush handle. Furthermore, the bias of the sliding lock into the notch provides the user with tactile and/or audible feedback that the brush head connector end 201 has been completely and properly inserted into the brush handle 101.

FIG. 2 also depicts certain elements of this embodiment which control the orientation of the brush head 102 to the brush handle 101. These elements include prongs 210, 217, 218 and 219 on the cover plate 207, prong receptacles 204, 220, 221, and 222 on the brush head connector base 202, the square-shaped cover plate hole 209, the square-shaped brush head connector 201, and the square-shaped sliding lock gap 213.

One embodiment of the brush handle 101 of FIG. 1 is typically made of a molded plastic. Embodiments may be formed from any material which securely holds the mechanism 103 and the brush head 102 when attached. For example, other embodiments may be formed from wood or metal or a combination of materials.

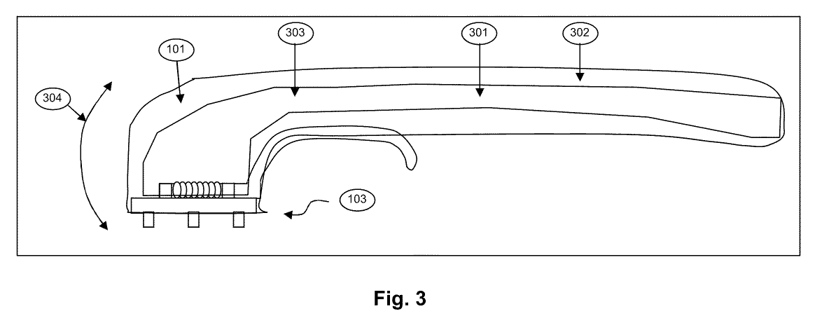

FIG. 3 shows sectional view of another embodiment of the brush handle 101 that may permit better contouring and reduced pressure during a pet's grooming. This embodiment of the brush handle 101 has an internal skeleton 301 over-molded with a flexible body 302 for gripping. The internal skeleton 301 is made of a hard material, such as a relatively hard plastic, that flexes in direction 304 at neck 303 and securely holds the mechanism 103 and securely holds the brush head when attached. As may be appreciated, other types of flexible brush handles also exist including a brush handle with an internal skeleton made of a less flexible material but with a thinner neck 303 or with a hinged or jointed neck 303. The over-molded body 302 is molded to the internal skeleton 301 to form a grip for a groomer. The over-molded body 302 is typically made of a flexible rubber but can also be made of any other soft material which can adhere or be molded to the internal skeleton and flex with the internal skeleton 301, such as a softer plastic.

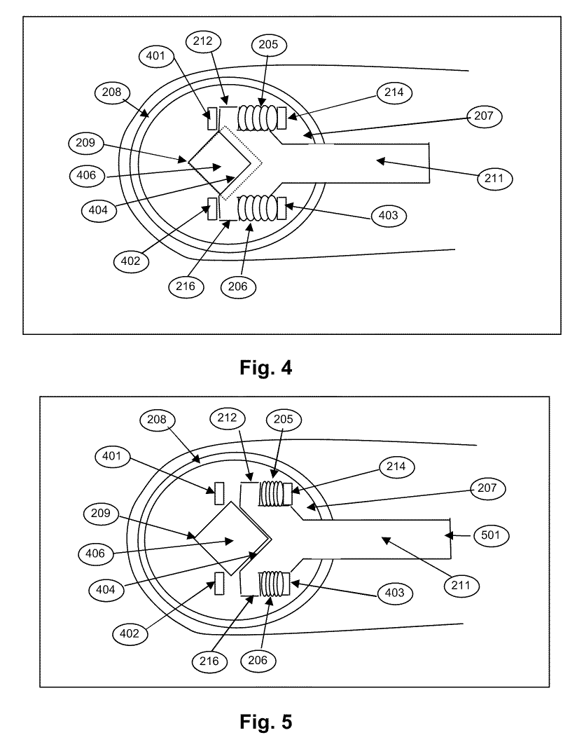

As described above, this embodiment uses a sliding lock 211 to couple the brush head 102 to the brush handle 101. FIG. 4 depicts a sectional view of the sliding lock mechanism in the engaged or locked position. FIG. 4 depicts the sliding lock 211, cover plate 207 and endcap 208. When engaged, the sliding lock at least partially overlaps the cover plate hole 209 and reduces the size of an aperture 406 formed by the cover plate hole and sliding lock. Furthermore, when engaged, the edge 404 of the sliding lock 211 fits into a notch 203 in the brush head connector end 223 of FIG. 2 to secure the brush head 102 of FIG. 2 to the brush handle 101 of FIG. 2. While this embodiment has a notch used to secure the brush head to the brush handle, it may be appreciated that the sliding lock may use other means to secure the brush head including a friction or a ball and socket mechanism.

FIG. 4 also depicts the sliding-lock arms 212 and 216, and cover plate retention arms 401 and 402 located on cover plate 207, which stop overextension of the sliding lock 211. To stop overextension, retention arm 401 abuts the sliding-lock arm 212 and retention arm 402 abuts the sliding-lock arm 216. While the retention arms limit the motion of the sliding lock, it should be appreciated that other means exist which also stop the sliding lock motion.

FIG. 4 also depicts sliding-lock arms 212 and 216, cover plate spring-base arms 403 and 214, and springs 205 and 206, which provide the bias that engages the sliding lock used to secure the brush head to the brush handle. Spring-base arm 403 provides a base to spring 206 and spring-base arm 214 provides a base to spring 205. Sliding lock arm 212 acts as a base for the other end of spring 205 and sliding-lock arm 216 acts as a base for the other end of spring 206. The springs 205 and 206, when uncompressed, expand between spring-base arms 403 and 214 and sliding-lock arms 212 and 216. The expanding springs force the sliding lock toward the hole 209 of cover plate 207. The movement of the sliding lock towards hole 209 reduces the size of aperture 406. The movement, as provided by the expanding springs, biases the sliding lock 211 into notch 203 of FIG. 2 when the brush head connector 201 of FIG. 2 is inserted into the mechanism 103 of FIG. 2.

FIG. 5 depicts the sectional view of the sliding lock of FIG. 4 where sliding lock 211 is disengaged or open. To disengage or open the sliding lock, force is applied to the distal end 501 of the sliding lock 211 which moves the sliding lock 211 in a direction away from the hole 209 of cover plate 207. This movement compresses spring 205 between spring-base arm 214 and sliding-lock arm 212 and compresses spring 206 between spring-base arm 403 and sliding-lock arm 216. The sliding lock's movement away from the cover plate hole 209 widens the size of aperture 406 formed by the cover plate hole and the sliding lock edge 404. When the aperture 406 widens, the sliding lock edge 404 disengages from notch 203 in the brush head connector end 201 of FIG. 2. At this point, the brush head 102 of FIG. 2 can be uncouple from brush handle 101 of FIG. 2 by withdrawing the brush head connector end 201 of FIG. 2 from the aperture 406. When force is no longer applied to the distal end of the sliding lock 501, the springs 205 and 206 uncompress and expand between the spring-base arms 403 and 214 and sliding-lock arms 212 and 216. The expanding springs bias the sliding lock 211 back to an engaged position that reduces the size of the aperture 406.

One embodiment that affixes the brush head to brush handle orientation uses a shaped brush head connector with a complementary shaped cover plate hole and a complementary shaped sliding lock edge. Because the cover plate hole and sliding lock edge form a complementary shape of the brush head connector, the brush head connector can only enter the cover plate hole and sliding lock edge at the appropriate orientation as defined by the shape. Furthermore, once the brush head connector passes through the cover plate hole and is secured by the sliding lock, the complementary shaped sides of the cover plate hole and sliding lock edge contact the sides of the brush head connector. This contact between the brush head connector and the sliding lock edge and cover plate hole holds the brush head in a fixed position on the brush handle and prevents reorientation of the brush head to the brush handle.

FIG. 8 shows an embodiment that uses a square-shaped brush head connector 201, a complementary square-shaped cover plate hole 209, and a complementary v-shaped sliding lock edge 404 to affix the brush head to brush handle orientation. The square-shaped brush head connector 201 and complementary cover plate hole 209 and sliding lock edge 404 affix the brush head to brush handle orientation in 90 degree increments. Initially, the brush head 102 is coupled to the brush handle 101 when the brush head connector end 201 passes through the cover plate hole 209 and is secured by the sliding lock as described before. Once connected, sides 605, 606, 607 and 608 of the square-shaped brush head connector 201 contact sides 601, 602, 603 and 604 of the cover plate hole 209 and sliding lock edge 404 to prevent reorientation of the brush head to brush handle.

To change the orientation, the brush head 102 is uncoupled from the brush handle 101 by opening or disengaging the sliding lock 211 as described above. Then the brush head 102 is reoriented to the appropriate angle allowed by the square-shaped brush head connector 201 and complementary square-shaped cover plate hole 209 and v-shaped sliding lock edge 404. Finally, the brush head connector end 201 is reinserted into the cover plate hole 209 until it is re-secured by the sliding lock 211. One example of reorientation initially has the brush head connector side 608 contacting cover plate hole side 604, brush head connector side 607 contacting cover plate hole side 603, brush head connector side 606 contacting cover plate hole side 602, and brush head connector side 605 contacting cover plate hole side 601. Additionally, brush head connector sides 608 and 607 contact the edge 404 of sliding lock 211. After a 90 degree orientation change through uncoupling and re-coupling of the brush head and brush handle, brush head connector side 608 contacts cover plate hole side 603, brush head connector side 607 contacts cover plate hole side 602, brush head connector side 606 contacts cover plate hole side 601, and brush head connector side 605 contacts cover plate hole side 604. Additionally, brush head connector sides 605 and 608 contact the sliding lock edge 404. While this example describes one change in orientation, other orientations exist which result in different pairings of the sides of the brush head connector to the complementary sides of the cover plate hole and sliding lock edge.

While this embodiment uses a square shape to fix the orientation in 90 degree increments, it should be appreciated that other degrees of orientation can also be achieved through different shapes. A triangle shape which changes the brush head 102 to brush handle 101 orientation to 120 degree increments is one example. Furthermore, while the cover plate hole 209 and sliding lock edge 404 share the same shape in this embodiment, only the cover plate hole 209 or sliding lock edge 404 need actually share the same shape as the brush head connector 201 to affix brush head to brush handle orientation.

Although this embodiment of the sliding lock shares a complementary shape of the brush head connector, the sliding lock may be a detent, peg or prong which fits into the notch, which may also be a slot or receptacle, on the brush head connector to affix the orientation of the brush head. Furthermore, while the sliding lock protrudes into the notch on the brush head connector, the sliding lock can also be a recess by which a portion of the brush head connector protrudes into to affix the orientation of the brush head to the brush handle.

One embodiment which facilitates the orientation of the brush head and brush handle uses prongs and prong receptacles. The insertion of the prongs into the prong receptacles fixes the brush head to brush handle orientation.

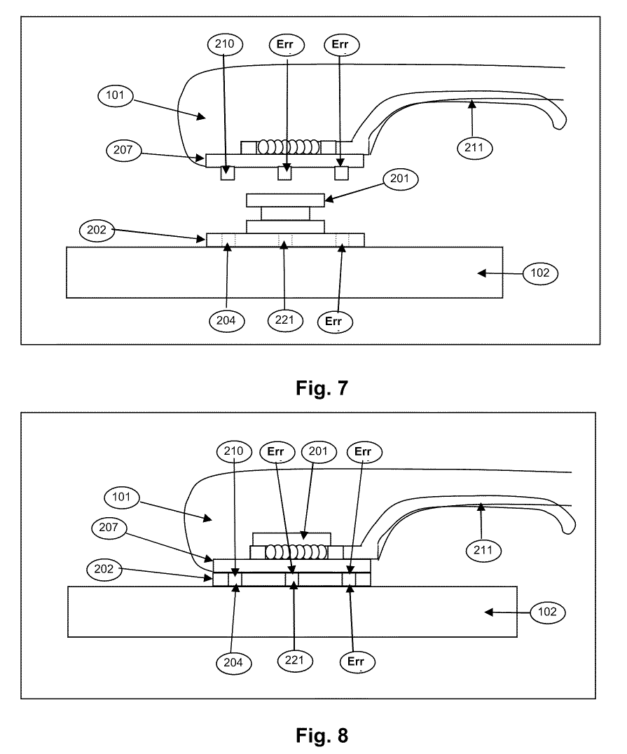

FIG. 7 depicts a lateral cross sectional view of the embodiment of FIG. 2 of an uncoupled brush handle 101 and the brush head 102. The brush handle 101 shows the sliding lock 211, cover plate 207, and prongs 210, 219 and 217 from FIG. 2. The brush head shows brush head connector end 201, brush head connector base 202, and prong receptacles 204, 221, and 222 from FIG. 2. When coupled, the prongs 210, 219 and 217 shown on brush handle 101 will be inserted in the prong receptacles 204, 221, and 222 on the brush head 102. Although not shown, prong 218 on brush handle 101 will be inserted into the prong receptacle 220. The brush head will be secured to the brush handle when the brush head connector end 201 is secured by the sliding lock 211.

FIG. 8 depicts the a lateral cross sectional view of FIG. 7 with the brush handle 101 and the brush head 102 coupled. FIG. 7 shows the sliding lock 211 securing the brush head connector end 201, to couple the brush head and brush handle. Furthermore, FIG. 7 shows an example of the insertion of the prongs on cover plate 207 into the prong receptacles on brush head connector base 202, specifically showing the insertion of prong 210 into prong receptacle 204, prong 219 into prong receptacle 221, and prong 217 into prong receptacle 222. Although not shown, prong 218 is inserted into prong receptacle 220.

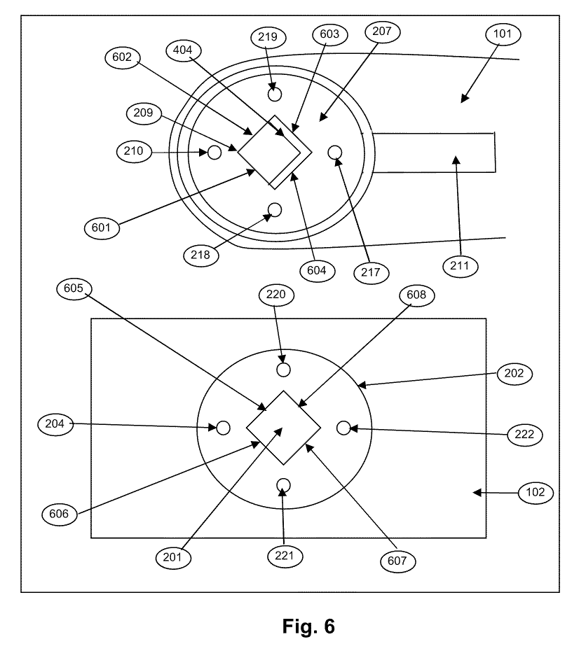

FIG. 6 also shows an embodiment that uses prongs and prong receptacles to fix the brush head to brush handle orientation. This embodiment allows 90 degree orientation changes using prongs 210, 217, 218 and 219 located on the cover plate 207 of the brush handle 101 and prong receptacles 204, 220, 221, and 222 located on the brush head connector base 202 of the brush head 102. When brush head 102 is coupled to brush handle 101, the prongs on cover plate 207 are inserted in the prong receptacles on the brush head connector base 202 and the brush head to brush handle orientation is fixed. In order to change the orientation, the brush head 102 is uncoupled from the brush handle 101 using the sliding lock 211, the brush head is reoriented to the brush handle, and the brush head is re-coupled to the brush handle. When brush head 102 is uncoupled from brush handle 101, the prongs on cover plate 207 are removed from the prong receptacles on the brush head connector base 202. When brush head 102 is re-coupled to brush handle 101 after reorientation, the prongs on cover plate 207 are inserted into different prong receptacles on the brush head connector base 202.

One example of a prong reorientation initially has prong 218 inserted into prong receptacle 220, prong 217 inserted prong receptacle 222, prong 219 inserted prong receptacle 221, and prong 210 inserted prong receptacle 204. After a 90 degree orientation change through uncoupling and re-coupling of the brush head and brush handle using the sliding lock, prong 217 is inserted into prong receptacle 220, prong 219 is inserted prong receptacle 222, prong 210 is inserted prong receptacle 221, and prong 218 is inserted prong receptacle 204. While this example describes one way of reorienting the brush head to brush handle using the prongs and prong receptacles, other pairings of prong and prong receptacles exist which also change the brush head to brush handle orientation.

While this embodiment changes the orientation in 90 degree increments, it should be appreciated that other degrees of orientation can also be achieved based on the placement of the prongs and prong receptacles. One example would be the addition of 4 more prongs and receptors to create an octagonal pattern of receptors and prongs which allows an orientation of 45 degree increments.

Although the embodiments discussed above use shapes and prongs to fix the brush head to brush handle orientation, either embodiment alone can fix the brush head to brush handle orientation. Furthermore, it may be appreciated that other embodiments can affix the brush head to brush handle orientation including those involving locking ratchets or dials.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. From the above description and drawings, it will be understood by those of ordinary skill in the art that the particular embodiments shown and described are for purposes of illustration only and are not intended to limit the scope of the present invention. References to details of particular embodiments are not intended to limit the scope of the invention.

What is claimed is:

1. A pet brush comprising:
a brush head;
a brush handle;
a mechanism;
the mechanism releasably coupling the brush head and brush handle wherein the brush head may be reoriented to the brush handle thereby changing the brushing direction.

2. The apparatus of claim 1 wherein the mechanism controlling the brush head to brush handle orientation comprises:
a set of prongs on the brush head;
a set of prong receptacles on the brush handle;
the prong receptacles receptive to receive the prongs.

3. The apparatus of claim 2 wherein the mechanism controlling the brush head to brush handle orientation comprises:
the prongs forming in a square pattern where each prong is on the corner of the square pattern;
the prong receptacles forming in a square-pattern where each prong receptacle is on the corner of the square pattern;
the square-patterned prong receptacles receptive to receive the square-patterned prongs.

4. The apparatus of claim 1 wherein the mechanism controlling the brush head to brush handle orientation comprises:
a shaped connecter on the brush head;
a shaped socket on the brush handle;
the shaped socket receptive to receive the shaped connector.

5. The apparatus of claim 4 wherein the mechanism controlling the brush head to brush handle orientation comprises:
the connector formed in a square shape;
the socket formed in a square shape;
the square-shaped socket receptive to receive the square-shaped connector.

6. A pet brush comprising,
a brush head;
the brush head comprised of a platform and a brush;
a brush handle;
a quick-release mechanism;
the mechanism releasably coupling the brush handle and brush head platform wherein the brush head platform may be rotated on the brush handle to change the brushing direction.

7. The apparatus of claim 6 wherein the mechanism controlling the brush head to brush handle rotation comprises:
a set of prongs on the brush head;
a set of prong receptacles on the brush handle;
the prong receptacles receptive to receive the prongs.

8. The apparatus of claim 7 wherein the mechanism controlling the brush head to brush handle rotation comprises:
the prongs forming in a square pattern where each prong is on the corner of the square pattern;
the prong receptacles forming in a square pattern where each prong receptacle is on the corner of the square pattern;
the square-patterned prong receptacles receptive to receive the square-patterned prongs.

9. The apparatus of claim 6 wherein the mechanism controlling the brush head to brush handle rotation comprises:
a shaped connecter on the brush head;
a shaped socket on the brush handle;
the shaped socket receptive to receive the shaped connector.

10. The apparatus of claim 9 wherein the mechanism controlling the brush head to brush handle rotation comprises:
the connector formed in a square shape;
the socket formed in a square shape;
the square-shaped socket receptive to receive the square-shaped connector.

11. A pet brush comprising,
a brush head;
the brush head comprised of a platform and a brush;
a brush handle;
a quick-release mechanism;
the mechanism releasably coupling the brush handle and brush head platform;
the mechanism controlling the orientation of the brush head on the brush handle.

12. The apparatus of claim 11 wherein the mechanism controlling the brush head to brush handle orientation comprises:
a set of prongs on the brush head;
a set of prong receptacles on the brush handle;
the prong receptacles receptive to receive the prongs.

13. The apparatus of claim 12 wherein the mechanism controlling the brush head to brush handle orientation comprises:
the prongs forming a square pattern where each prong is on the corner of the square pattern;
the prong receptacles forming a square pattern where each prong receptacle is on the corner of the square pattern;
the square-patterned prong receptacles receptive to receive the square-patterned prongs.

14. The apparatus of claim 11 wherein the mechanism controlling the brush head to brush handle orientation comprises:
a shaped connecter on the brush head;
a complementary shaped socket on the brush handle;
the complementary shaped socket receptive to receive the shaped connector.

15. The apparatus of claim 14 wherein the mechanism controlling the brush head to brush handle orientation comprises:
the connector formed in a square shape;
the socket formed in a square shape;
the square-shaped socket receptive to receive the square-shaped connector.

16. A method for providing the orientation of a pet brush head in relation to a pet brush handle on a pet brush, the method comprising:
orienting the brush head to the brush handle using a mechanism, wherein the mechanism performs the operations comprising:
releasably coupling the brush head to the brush handle;
controlling the orientation the brush head to the brush handle.

17. The method of claim 16 wherein the providing operation further comprises:
receiving a set of prongs on the brush head in a set prong receptacles on the brush handle in the mechanism.

18. The method of claim 17 wherein the providing operation further comprises:
receiving the set of prongs, where the prongs form a square pattern and each prong is on the corner of the square pattern, in the prong receptacles, where the prong receptacles form a square pattern and each prong receptacle is on the corner of the square pattern.

19. The method of claim 16 wherein the providing operation further comprises:
receiving a shaped connecter on the brush head in a complementary shaped socket on the brush handle in the mechanism.

20. The method of claim 19 wherein the providing operation further comprises:
receiving the connector, where the connector is a square shape, in the socket, where the socket is a complementary square shape.
